(19) United States
(12) Patent Application Publication
(10) Pub. No.: US 2011/0070430 A1
(43) Pub. Date: Mar. 24, 2011

(54) DOUBLE-SIDED PRESSURE-SENSITIVE ADHESIVE SHEET

(75) Inventors: Mitsuyoshi SHIRAI, Ibaraki-shi (JP); Akiko TAKAHASHI, Ibaraki-shi (JP); Shouhei WADA, Ibaraki-shi (JP); Toshihide SUZUKI, Ibaraki-shi (JP); Kenichi YAMAMOTO, Ibaraki-shi (JP); Tatsuya TSUKAGOSHI, Ibaraki-shi (JP)

(73) Assignee: NITTO DENKO CORPORATION, Ibaraki-shi (JP)

(21) Appl. No.: 12/888,787

(22) Filed: Sep. 23, 2010

(30) Foreign Application Priority Data
Sep. 24, 2009 (JP) 2009-219118

(51) Int. Cl. B32B 27/08

(52) U.S. Cl. 428/336; 428/354; 428/337; 428/345

(57) ABSTRACT

A double-sided pressure-sensitive adhesive (PSA) sheet having a plastic film as a substrate is provided, with the property of corroding a metal not in contact therewith being suppressed. This PSA sheet has a PSA layer that uses a water-dispersed acrylic PSA composition on each side of the plastic film substrate. The PSA composition contains a water-dispersed acrylic polymer synthesized using a sulfur-containing chain transfer agent. The PSA sheet has the emission of sulfur-containing gas of 0.043 μg or less per 1 cm² surface area of the PSA sheet, when converted to SO₄²⁻, in a gas generation test under which the PSA sheet is heated at 85° C. for one hour.

### BACKGROUND OF THE INVENTION

1. Field of the Invention

The present invention relates to a water-dispersed pressure-sensitive adhesive (hereinafter referred to as PSA) composition having an acrylic co-polymer as a base polymer and a double-sided PSA sheet having a PSA layer formed from the PSA composition on each side of a plastic film substrate.

This application claims priority to Japanese Patent Application No. 2009-219118 filed on Sep. 24, 2009, the entire contents of which are incorporated herein by reference.

2. Description of the Related Art

Compared to a PSA composition of a type where the adhesive constituent is dissolved in an organic solvent, a PSA composition using a water-dispersed acrylic polymer is desirable from the point of view of environmental health. Therefore, a PSA sheet using a water-dispersed acrylic PSA composition is being used in a variety of field as a double-sided tape and in other morphologies. As one example of such field of utilization, various electronic equipments such as home appliances and OA equipments may be cited. As a technical literature regarding PSA that uses an acrylic emulsion, Japanese Patent Application Publication No. S61-12775 may be cited.

### SUMMARY OF THE INVENTION

Depending on the usage mode, a PSA sheet formed from a water-dispersed acrylic PSA composition sometimes causes a metal (for instance, silver) that is not in direct contact with the PSA sheet to corrode. For instance, in a situation where a PSA sheet and a metal material co-exist in a limited space such as inside the housing of an electronic device, corrosion sometimes occur in the non-contacting metal material described above. Such an event may become a factor provoking a contact defect due to corrosion of a metal constituting the base board or the wiring of the electronic device. In addition, the corrosion of metal described above may create problems in other fields than electronic device, such as a decrease in the quality of external appearance. Thus, a PSA sheet that does not corrode metal is desired.

The present invention was devised to resolve such problems described above, and an object is to provide a double-sided PSA sheet, which is a PSA sheet having a PSA layer using a water-dispersed acrylic PSA composition on each side of plastic film substrate, in which the described above non-contact metal corrosion has been suppressed.

The present inventors reasoned that the event in which the PSA sheet causes the non-contact metal to corrode was provoked by a metal-corrosive substance released from the PSA sheet, and focused on sulfur-containing gas (that is to say, a gaseous compound containing sulfur as a structural element) as the metal-corrosive substance. In addition, they found out that a sulfur compound widely used as chain transfer agent in the manufacture of acrylic polymer emulsion for PSA (sulfur-containing chain transfer agent, typically n-lauryl mercaptan) may be a major source of the sulfur-containing gas described above. Then, they discovered that even if a sulfur-containing chain transfer agent is used, the problem of metal corrosion described above may be solved by greatly decreasing the emission of the sulfur-containing gas described above to complete the present invention.

According to the present invention, a double-sided PSA sheet is provided comprising a plastic film substrate and a PSA layer formed from a water-dispersed PSA composition and provided on each side of said substrate. The PSA composition described above contains a water-dispersed acrylic polymer that was synthesized using a chain transfer agent containing sulfur as a structural element (sulfur-containing chain transfer agent). In a gas generation test under which the PSA sheet is heated at 85° C. for one hour, the emission of gas containing sulfur as a structural element (sulfur-containing gas) per 1 cm² surface area of the sheet described above is 0.043 μg or less when converted to SO₄²⁻ (hereinafter, this may be represented as “0.043 μg SO₄²⁻/cm² or less”). According to such PSA sheet, owing to the fact that generation of sulfur-containing gas (in particular, gas that may react with a metal such as silver to form a sulfide, for instance, H₂S and SO₂) is suppressed, the corrosion of metal described above (for instance, formation of sulfide described above) can be prevented or suppressed efficiently. In addition, since the use of sulfur-containing chain transfer agent is allowed in the synthesis of the water-dispersed acrylic polymer, adjusting the polymer to a suitable molecular weight is facilitated. According to the PSA composition containing an acrylic polymer with a suitably adjusted molecular weight, a more highly efficient PSA sheet may be formed. Consequently, according to the present invention, a double-sided PSA sheet having excellent metal corrosion prevention properties and better adhesive capability may be provided.

In one preferred mode of the technique disclosed herein, the sulfur-containing chain transfer agent described above is a chain transfer agent that does not substantially generate the sulfur-containing gas described above, in the gas generation test described above. According to the PSA sheet of such mode, a higher level in metal corrosion prevention properties may be realized.

As the sulfur-containing chain transfer agents described above, those having as a main component (that is to say, a constituent occupying 50% by mass or greater in the sulfur-containing chain transfer agent) a mercaptan having one or fewer hydrogen atoms bonded to the carbon atom to which the mercapto group is bonded (including mercaptans with no hydrogen atom bonded to the carbon atom), or a mercaptan in which the carbon atom has a resonance structure, may be used preferably. As preferred examples of such mercaptan, tertiary mercaptans and aromatic mercaptans may be cited.

The subject of application of the art disclosed herein is a double-sided PSA sheet (also known as two-sided PSA sheets, double-faced PSA sheets or double-stick sheets) provided with the PSA layer described previously on each side of a substrate. With a PSA sheet having such a constitution, the importance of adjusting the molecular weight of the acrylic polymer is particularly pronounced. Consequently, the ability to use a sulfur-containing chain transfer agent during the synthesis of the water-dispersed acrylic polymer is of particular significance.

In one preferred mode of the double-sided PSA sheet disclosed herein, when the Young's modulus of the above-mentioned plastic film substrate is Y (kPa) and the thickness of the substrate is h (mm), it is desirable that the bending elasticity coefficient E represented by the following mathematical formula (A): E=Yh³; is 5×10⁴ or less (more preferably 0.001 or greater and 4.5×10⁴ or less, and even more preferably 0.01 or greater and 4×10⁴ or less).

In one preferred mode of the double-sided PSA sheet disclosed herein, the thickness of the plastic film substrate is 1 μm or greater and 300 μm or less. This may realize a double-sided PSA sheet having a suitable degree of firmness and curved-surface-conformability.

In another preferred mode, a corona discharge treatment, a plasma treatment or an ITRO treatment is performed on each side of the plastic film substrate. Here, ITRO treatment indicates the generality of the surface quality improvement treatments for forming a silicon oxide film of nanometer order on the substrate surface by combustion chemical vapor deposition (CCVD). These surface quality improvement treatments may improve the anchoring ability of the substrate surface with respect to the PSA layer.

In another preferred mode, an undercoat layer, or the like, containing an oxazoline group is conferred on the surface of the substrate. The anchoring ability of the substrate surface may also be improved by such a treatment. The undercoat layer may be conferred to a substrate with an untreated surface, or may be conferred once the substrate has been subjected to such a surface quality improvement treatment as described above. The thickness of the undercoat layer is preferably 0.01 μm or greater but less than 3 μm. This may realize a double-sided PSA sheet in which the anchoring ability of the PSA layer has been improved, while desirable adhesive properties are maintained.

In another preferred mode, the water contact angle on the surface of the plastic film substrate is 0 degrees or greater and 90 degrees or less. This may realize a double-sided PSA sheet in which the anchoring ability of the PSA layer is excellent.

In another preferred mode, the plastic film substrate is a polyester film. A polyester film is desirable from such points of views as dimensional stability, economy (costs), processability, tensile strength and heat resistance.

Since, as described above, the double-sided PSA sheet provided by the art disclosed herein has an extremely low emission of metal-corroding gas, it is suitable as a double-sided PSA sheet used inside an electronic device. For instance, it may be used preferably as a double-sided PSA sheet used for joining parts in an internal space where metal materials such as circuit base board and wiring co-exist. Consequently, in another aspect, the present invention provides an electronic device having within, a joining site mediated by the PSA sheet described above.

The contents disclosed herein also include the following:

A double-sided PSA sheet provided with a PSA layer formed from a water-dispersed PSA composition and a plastic film substrate supporting the PSA layer,

the PSA composition containing an acrylic polymer synthesized using at least one species of mercaptan selected from the group consisting of tertiary mercaptans and aromatic mercaptans, and

the emission of sulfur-containing gas being 0.043 μg SO₄²⁻/cm² or less in a gas generation test whereby the double-sided PSA sheet is heated at 85° C. for one hour.

In addition, in a preferred mode of any double-sided PSA sheet disclosed herein (may be a double-sided PSA sheet prepared using any PSA composition disclosed herein), the PSA sheet satisfies at least one among properties (a) to (e) described below. Therefore, the contents disclosed herein include a double-sided PSA sheet, which is any double-sided PSA sheet disclosed herein and in addition satisfying at least one among properties (a) to (e) described below.

(a) Toluene emission is 20 μg or less per 1 g of PSA sheet.

(b) Ethyl acetate emission is 20 μg or less per 1 g of PSA sheet.

(c) Total emission of volatile organic compounds (VOC) is 500 μg or less per 1 g of PSA sheet

(d) Breaking strength in the substrate flow direction (Machine Direction: MD) is 130 MPa or greater and 500 MPa or less.

(e) Elongation at break in the substrate flow direction (Machine Direction: MD) is 50% or greater and 300% or less.

### BRIEF DESCRIPTION OF THE DRAWINGS

FIG. 1 is a cross-sectional view showing schematically one constitution example of PSA sheet according to the present invention;

FIG. 2 is a cross-sectional view showing schematically another constitution example of PSA sheet according to the present invention;

FIG. 3 is an explanatory figure schematically indicating the method to carry out a metal corrosivity test; and

FIG. 4 is a cross-sectional view showing schematically a test piece laminated onto an adherend in a curved-surface-conformability test.

### DETAILED DESCRIPTION OF THE INVENTION

Preferred embodiments of the present invention will be described below. Technical matters necessary to practice the invention, other than those specifically referred to in the present description, may be understood as design matters for a person skilled in the art that are based on the related art in the pertinent field. The present invention may be practiced based on the contents disclosed herein and common general technical knowledge in the pertinent field. In the following description, like reference numerals are assigned to members or sites producing like effects, and duplicated descriptions are sometimes omitted or simplified.

The double-sided PSA sheet provided by the present invention is a substrated double-sided PSA sheet of a morphology having a PSA layer formed from any water-dispersed PSA composition disclosed herein on each side of a plastic film substrate (support). The concept of PSA sheet herein includes those referred to as adhesive tape, adhesive label, adhesive film and the like. Note that, although the PSA layer described above is typically formed continuously, it is not limited to such a morphology, and the PSA layer may be formed in a regular or random pattern of, for instance, dots, stripes or the like. In addition, the PSA sheet provided by the present invention may be in roll form or in sheet (spread) form. Alternatively, the PSA sheet may be of morphologies that have been further processed into a variety of shapes.

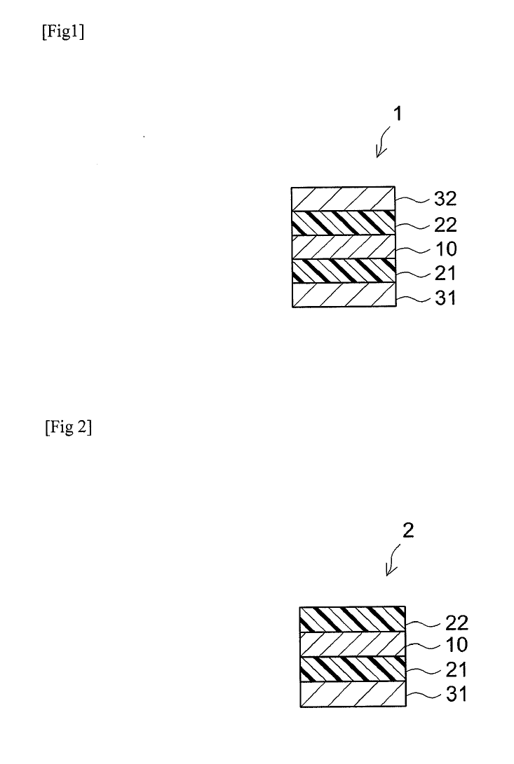

The double-sided PSA sheet disclosed herein may have cross-sectional structures, for instance, shown schematically in FIG. 1 to FIG. 2. The PSA sheet 1 shown in FIG. 1 has a constitution in which PSA layers 21 and 22 are provided respectively on first and second sides of a plastic film substrate 10 (both non-releasing) and these PSA layers are respectively protected by release liners 31 and 32, of which at least the PSA layer side is a release side. The PSA sheet 2 shown in FIG. 2 has a constitution in which PSA layers 21 and 22 are provided respectively on first and second sides of a plastic film substrate 10 (both non-releasing), the PSA layer 21, which is the first among these, is protected by a release liner 31, of which each side is a release side. This type of PSA sheet 2 can have a constitution in which the PSA layer 22 is also protected by the release liner 31, by rolling the PSA sheet and bringing the second PSA layer 22 in contact with the back side of the release liner 31.

The PSA sheet disclosed herein is characterized by the emission of sulfur-containing gas being 0.043 μg SO₄²⁻/cm² or less (more preferably 0.03 μg SO₄²⁻/cm² or less) in a gas generation test whereby the PSA sheet is heated at 85° C. for one hour. A PSA sheet with such excellent metal corrosion prevention ability and adhesive properties is suitable, for instance, as a PSA sheet used inside an electronic device.

The sulfur-containing gas emission described above can be calculated, for instance, by determining as SO₄²⁻ mass the mass of sulfur-containing gas (may be H₂S, SO₂ and the like) emitted from the PSA sheet in a gas generation test whereby a PSA sheet is heated at 85° C. for one hour, and dividing this mass by the surface area of the PSA sheet described above. More concretely, determination can be, for instance, by the method for measuring sulfur-containing gas emission described in the examples below. In one preferred mode, the sulfur-containing gas emission of the PSA sheet is essentially zero (for instance, as described below, below the detection limit, typically below 0.02 μg SO₄²⁻/cm², in a sulfur-containing gas emission measurement with a PSA sheet of on the order of 0.1 g as the measurement sample).

In one preferred mode of the PSA sheet disclosed here, in a metal corrosivity test (more concretely, for instance, the metal corrosivity test carried out by the procedure of the examples described later) whereby 1 g of the PSA sheet and a silver plate (for instance, a silver plate is used, comprising silver with a purity exceeding 99.95%, having a size of 1 mm×10 mm×10 mm) are enclosed in a vessel of 50 mL in volume so as not to be in contact with each other, the vessel is sealed and kept at 85° C. for one week, no corrosion is observed on the silver plate (Property D). A PSA sheet with such an excellent metal corrosion prevention ability is particularly suitable as a PSA sheet used inside an electronic device. Note that in the present invention, “does not corrode silver plate” is defined as, when a silver plate after the metal corrosivity test described above (after one week has elapsed) and an unused silver plate (prior to the test) are compared by visual inspection, no alteration in the appearance (disappearance of metal sheen, coloration, or the like) is observed.

The water-dispersed PSA composition used for forming the PSA layer contains a water-dispersed acrylic polymer. This water-dispersed acrylic polymer is an acrylic polymer composition in emulsion form in which an acrylic polymer is dispersed in water. In the technology disclosed herein, the acrylic polymer is used as base polymer of PSA (basic component of PSA) to constitute the PSA layer. For instance, it is desirable that 50% by mass or greater of the PSA is acrylic polymer. As such acrylic polymer, one having alkyl (meth)acrylate as the main constituent monomer (main monomeric constituent, that is to say, a constituent occupying 50% by mass or greater of the total amount of monomers constituting the acrylic polymer) may be used preferably.

Note that herein, “(meth)acrylate” is meant to indicate acrylate and methacrylate comprehensively. Similarly, meant to indicate comprehensively are, respectively, “(meth)acryloyl” for acryloyl and methacryloyl, and “(meth)acrylic” for acrylic and methacrylic.

As alkyl (meth)acrylates, for instance, compounds represented by the following general formula (I) can be used suitably:

CH₂═C(R¹)COOR² (1)

Here, R¹ in the formula (1) represents a hydrogen atom or a methyl group. R² represents an alkyl group having 1 to 20 carbon atoms. Examples of R² include alkyl groups such as methyl group, ethyl group, propyl group, isopropyl group, butyl group, isobutyl group, s-butyl group, t-butyl group, pentyl group, isoamyl group, neopentyl group, hexyl group, heptyl group, octyl group, isooctyl group, 2-ethylhexyl group, nonyl group, isononyl group, decyl group, isodecyl group, undecyl group, dodecyl group, tridecyl group, tetradecyl group, pentadecyl group, hexadecyl group, heptadecyl group, octadecyl group, nonadecyl group and eicosyl group and the like. Among these, from the point of view of the storage elastic modulus, or the like, of the PSA, an alkyl (meth)acrylate in which R² is an alkyl group having 2 to 14 carbon atoms (hereafter, such a range of number of carbon atoms may sometimes be represented as “C₂₋₁₄”) is desirable and an alkyl (meth)acrylate in which R² is a C₂₋₁₀ alkyl group is more desirable. In particular, as preferred R², butyl group and 2-ethylhexyl group are given as examples.

As concrete examples of alkyl (meth)acrylates, methyl (meth)acrylate, ethyl(met)acrylate, propyl (meth)acrylate, isopropyl (meth)acrylate, butyl (meth)acrylate, isobutyl (meth)acrylate, s-butyl (meth)acrylate, t-butyl (meth)acrylate, pentyl(meth)acrylate, isoamyl (meth)acrylate, neopentyl (meth)acrylate, hexyl (meth)acrylate, heptyl (meth)acrylate, octyl (meth)acrylate, isooctyl (meth)acrylate, 2-ethyl hexy (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, eicosyl (meth)acrylate, and the like may be cited. As particularly desirable alkyl (meth)acrylates, butylacrylate and 2-ethylhexylacrylate are given as examples.

In one preferred mode, of the total amount of alkyl (meth)acrylate used in the synthesis of the acrylic polymer, on the order of 50% by mass or greater (more preferably 70% by mass or greater, for instance on the order of 90% by mass or greater) is an alkyl (meth)acrylate in which R² in the above formula (I) is C₂₋₁₄ (preferably C₂₋₁₀, and more preferably C₄₋₈). According to such a monomer composition, obtaining an acrylic polymer for which the store elastic modulus at close to ordinary temperature is in a suitable range for a PSA is facilitated. Essentially all of the alkyl (meth)acrylate may be C₂₋₁₄ alkyl (meth)acrylate.

The alkyl (meth)acrylate constituting the acrylic polymer in the art disclosed herein may be butylacrylate (BA) alone, may be 2-ethylhexylacrylate (2EHA) alone, or may be both species of BA and 2EHA. When BA and 2EHA are used in combination as alkyl (meth)acrylate, there is no particular limitation on their ratio.

As monomers constituting the acrylic polymer, other monomers that are co-polymerizable with alkyl (meth)acrylate (sometimes may be referred to as “co-polymerizing monomer constituent”) may be used in such a range that alkyl (meth)acrylate is the main constituent. The proportion of alkyl (meth)acrylate with respect to the total amount of monomers constituting the acrylic polymer may be on the order of 80% by mass or greater (typically 80 to 99.8% by mass) and preferably 85% by mass or greater (for instance 85 to 99.5% by mass). The proportion of alkyl (meth)acrylate may be 90% by mass or greater (90 to 99% by mass).

These co-polymerizing monomers may be useful for introducing a crosslinking site into the acrylic polymer or for increasing the cohesive strength of the acrylic polymer. Such co-polymerizing monomer can be used alone or by combining two species or more.

More particularly, as co-polymerizing monomers for introducing a crosslinking site into the acrylic polymer, various functional group-containing monomers (typically, a heat-crosslinking functional group-containing monomer for introducing a crosslinking site that crosslinks by heat into the acrylic polymer) can be used. By using such a functional group-containing monomer, the adhesive strength to the adherend may be increased. Such a functional group-containing monomer suffices to be a monomer that is co-polymerizable with alkyl (meth)acrylate and may provide a functional group that is a crosslinking site, and is not limited in particular. For instance, functional group-containing monomers such as the following can be used, alone or by combining two species or more.

Carboxyl group-containing monomers: for instance, ethylenic unsaturated monocarboxylic acids such as acrylic acid, methacrylic acid and crotonic acid; ethylenic unsaturated dicarboxylic acids such as maleic acid, itaconic acid and citraconic acid, and anhydrides thereof (such as maleic anhydride and itaconic anhydride).

Hydroxyl group-containing monomers: for instance, hydroxyalkyl (meth)acrylates such as 2-hydroxyethyl (meth)acrylate, 2-hydroxypropyl (meth)acrylate, 3-hydroxypropyl (meth)acrylate and 2-hydroxybutyl (meth)acrylate; and unsaturated alcohols such as vinyl alcohol and allyl alcohol.

Amide group-containing monomers: for instance, (meth)acrylamide, N,N-dimethyl (meth)acrylamide, N-butyl (meth)acrylamide, N-methylol (meth)acrylamide, N-methylol propane (meth)acrylamide, N-methoxy methyl (meth)acrylamide and N-butoxy methyl (meth)acrylamide.

Amino group-containing monomer: for instance, aminoethyl (meth)acrylate, N,N-dimethylaminoethyl (meth)acrylate and t-butylaminoethyl (meth)acrylate.

Monomers having an epoxy group: for instance, glycidyl (meth)acrylate, methylglycidyl (meth)acrylate and allyl glycidyl ether.

Cyano group-containing monomers: for instance, acrylonitrile and methacrylonitrile.

Keto group-containing monomers: for instance, diacetone (meth)acrylamide, diacetone (meth)acrylate, methyl vinyl ketone, ethyl vinyl ketone, allyl acetoacetate and vinyl acetoacetate.

Monomers having a nitrogen atom-containing ring: for instance, N-vinyl-2-pyrrolidone, N-methylvinyl-2-pyrrolidone, N-vinylpyridinium salt, N-vinylpiperidone, N-vinylpyrimidine, N-vinylpiperazine, N-vinylpyrazine, N-vinylpyrrole, N-vinylimidazole, N-vinyloxazole, N-vinylmorpholine, N-vinylcaprolactam and N-(meth)acryloylmorpholine.

Alkoxy silyl group-containing monomers: for instance, 3-(meth)acryloxypropyl trimethoxy silane, 3-(meth)acryloxypropyl triethoxy silane, 3-(meth)acryloxypropyl methyldimethoxy silane and 3-(meth)acryloxypropyl methyldiethoxy silane.

Among these functional group-containing monomers, one, two or more species selected from carboxyl group-containing monomers or acid anhydrides thereof can be used preferably. Essentially all of the functional group-containing monomer constituent may be a carboxyl group-containing monomer. Among these, as preferred carboxyl group-containing monomers, acrylic acid and methacrylic acid may be given as examples. One of these may be used alone or the acrylic acid and the methacrylic acid may be combined in any proportion and used.

The functional group-containing monomer constituent described above is preferably used in ranges of, for instance, about 12 parts in mass or less (for instance, about 0.5 to 12 parts in mass and preferably about 1 to 8 parts in mass) with respect to 100 parts in mass of alkyl (meth)acrylate. If the amount of functional group-containing monomer constituent is too high, the cohesive strength becomes too high, which may tend to decrease the adhesive properties (for instance adhesive strength).

In addition, in order to increase the cohesive strength of the acrylic polymer, aside from the functional group-containing monomers described above, other co-polymer constituents can be used. As such co-polymer constituents, for instance, vinyl esters such as vinyl acetate and vinyl propionate; aromatic vinyl compounds such as styrene, substituted styrene (such as a-methyl styrene) and vinyl toluene; non-aromatic ring-containing (meth)acrylates such as cycloalkyl (meth)acrylate [such as cyclohexyl (meth)acrylate and cyclopentyl di(meth)acrylate] and isobornyl (meth)acrylate; aromatic ring-containing (meth)acrylates such as aryl (meth)acrylate [for instance phenyl (meth)acrylate], aryloxy alkyl (meth)acrylate [for instance phenoxy ethyl (meth)acrylate] and arylalkyl (meth)acrylate [for instance benzyl (meth)acrylate]; olefins such as ethylene, propylene, isoprene, butadiene and isobutylene; chlorine-containing monomers such as polyvinyl chloride and vinylidene chloride; isocyanate group-containing monomers such as 2-(meth)acryloyloxyethyl isocyanate; alkoxy group-containing monomers such as methoxyethyl (meth)acrylate and ethoxyethyl (meth)acrylate; vinyl ethers such as methyl vinyl ether and ethyl vinyl ether; and the like, may be cited.

As other examples of co-polymerizing monomers, monomers having a plurality of functional groups within a single molecule may be cited. Examples of such multifunctional monomer include 1,6-hexanediol di(meth)acrylate, ethyleneglycol di(meth)acrylate, diethyleneglycol di(meth)acrylate, triethyleneglycol di(meth)acrylate, tetraethyleneglycol di(meth)acrylate, (poly)ethyleneglycol di(meth)acrylate, propyleneglycol di(meth)acrylate, (poly)propyleneglycol di(meth)acrylate, neopentylglycol di(meth)acrylate, pentaerythritol di(meth)acrylate, trimethylol propane tri(meth)acrylate, pentaerythritol tri(meth)acrylate, dipentaerythritol hexa(meth)acrylate, glycerin di(meth)acrylate, epoxy acrylate, polyester acrylate, urethane acrylate, divinyl benzene, butyl di(meth)acrylate, hexyl di(meth)acrylate, and the like.

As methods for obtaining water-dispersed acrylic polymers by polymerizing such monomers, polymerization methods that are well known and in common use can be adopted, and preferably emulsion polymerization can be used. As methods for supplying monomers when carrying out emulsion polymerization, batch feeding method whereby the entirety of the monomers is supplied in a single batch, continuous supply (instillation) method, fractional provision (instillation) method, and the like, can be adopted suitably. A portion or the entirety of the monomers (typically, the entirety) is mixed and emulsified beforehand with water (typically, a suitable amount of emulsifier is used along with water), and the emulsion thereof (monomer emulsion) may be supplied into the reaction vessel in a single batch, gradually or fractionally. The polymerization temperature can be selected suitably according to the species of the monomer, the species of the polymerization initiator, and the like, to be used, and can be, for instance, about 20° C. to 100° C. (typically 40° C. to 80° C.).

As polymerization initiators used during polymerization, it can be selected suitably according to the type of polymerization method from among polymerization initiators that are well known and in common use. For instance, in emulsion polymerization methods, azo series polymerization initiators may be used preferably. Examples of azo initiators include 2,2′-azobisisobutylonitrile, 2,2′-azobis(2-methylpropionamidine) disulfate, 2,2′-azobis(2-amidino propane) dihydrochloride, 2,2′-azobis[2-(5-methyl-2-imidazoline-2-yl)propane]dihydrochloride, 2,2′-azobis(N,N′-dimethyleneisobutylamidine), 2,2′-azobis[N-(2-carboxyethyl)-2-methylpropionamidine]hydrate, 2,2′-azobis(4-methoxy-2,4-dimethylvaleronitrile), 2,2′-azobis(2,4-dimethylvaleronitrile), 2,2′-azobis(2-methylbutylonitrile), 1,1′-azobis(cyclohexane-1-carbonitrile), 2,2′-azobis(2,4,4-trimethylpentane), dimethyl-2,2′-azobis(2-methylpropionate), and the like.

As other examples of polymerization initiator, persulfates such as potassium persulfate and ammonium persulfate; peroxide initiators such as benzoyl peroxide, t-butyl hydroperoxide, di-t-butyl peroxide, t-butylperoxy benzoate, dicumyl peroxide, 1,1-bis(t-butylperoxy)-3,3,5-trimethyl cyclohexane, 1,1-bis(t-butylperoxy)cyclododecane and hydrogen peroxide; substituted ethane initiators such as phenyl-substituted ethane; aromatic carbonyl compounds; and the like, may be cited. As further other examples of polymerization initiators, redox initiators by combination of a peroxide and a reducing agent may be cited. Examples of such redox initiators include combination of a peroxide and ascorbic acid (such as combination of hydrogen peroxide water and ascorbic acid), combination of a peroxide and iron(II) salt (such as combination of hydrogen peroxide water and iron(II) salt), combination of a persulfate and sodium hydrogen sulfite, and the like.

Such polymerization initiators can be used alone or in a combination of two species or more. The amount of polymerization initiator used suffices to be an amount used conventionally, and can be selected from a range of, for instance, about 0.005 to 1 parts in mass (typically 0.01 to 1 parts in mass) with respect to 100 parts in mass of all monomers combined.

In a typical mode of the art disclosed herein, during the emulsion polymerization described above, a chain transfer agent (may also be understood as a molecular weight adjuster or a polymerization degree adjuster) comprising a compound containing sulfur as a structural element is used. The type and amount used of such a sulfur-containing chain transfer agent can be set by taking into account the target properties of the PSA sheet, other materials constituting the PSA sheet, and the like, so that the sulfur-containing gas emission described above is 0.043 μg SO₄²⁻/cm² or lower (preferably 0.03 μg SO₄²⁻/cm² or lower). The sulfur-containing gas emission described above is determined by determining by converting into SO₄²⁻ mass the mass of sulfur-containing gas (may be H₂S, SO₂ and the like) emitted from the PSA sheet in a gas generation test whereby a PSA sheet is heated at 85° C. for one hour, and dividing this mass by the surface area of the PSA sheet. More concretely, determination can be, for instance, by the method for measuring sulfur-containing gas emission described in the examples below. In one preferred mode, regardless of the use of a sulfur-containing chain transfer agent, the sulfur-containing gas emission of the PSA sheet is essentially zero (for instance, as described below, below the detection limit, typically below 0.02 μg SO₄²⁻/cm², in a sulfur-containing gas emission measurement with a PSA sheet of on the order of 0.1 g as the measurement sample).

Note that, in order to exert the desired adhesive properties, it is desirable that the amount of sulfur-containing chain transfer agent used is on the order of 0.001 parts in mass or greater (typically about 0.001 to 5 parts in mass) with respect to 100 parts in mass of all monomers. In general, a suitable result may be realized by using about 0.005 to 2 parts in mass (typically about 0.01 to 1 parts in mass) of sulfur-containing chain transfer agent with respect to 100 parts in mass of all monomers.

In the art disclosed herein, a compound having a structural moiety represented by C—SH, that is to say, a mercaptan, can be used as sulfur-containing chain transfer agent. In order to realize a PSA sheet that satisfies the sulfur-containing gas emission range, it is preferable that the sulfur-containing chain transfer agent be of, as its main ingredient, one, two or more mercaptans selected from mercaptans in which only one hydrogen atom (H) is bonded to the carbon atom (C) to which a mercapto group (—SH) is bonded (for instance, mercaptans in which a mercapto group is bonded to a secondary carbon atom, that is to say secondary mercaptans), mercaptans in which no hydrogen atom is bonded to the SH-bearing carbon atom (for instance, mercaptans in which a mercapto group is bonded to a tertiary carbon atom), and mercaptans in which the carbon atom described above has a resonance structure (aromatic mercaptans or the like). It is unlikely for mercaptans with such structures to become a sulfur-containing gas generation source in an acrylic polymer synthesized using the mercaptan. Consequently, according to a water-dispersed PSA composition containing such an acrylic polymer, a PSA sheet may be formed to have adequate adhesive properties, yet suppressed metal corrosivity. Hereafter, mercaptan having such structure as described above may be referred to as “non-corrosive mercaptan”. Such a non-corrosive mercaptan may have a structure in which the mercapto group-bearing carbon atom may be bonded to any atom other than a hydrogen atom. For instance, a mercaptan having a structure in which the mercapto group bearing carbon atom is bonded to other 2 or 3 carbon atoms can be used preferably.

As one preferred example of non-corrosion mercaptan, mercaptans having a structure in which a mercapto group is bonded to a tertiary carbon atom (for instance, tertiary alkyl group), that is to say, tertiary mercaptans may be cited. Examples of tertiary mercaptans, tertiary butyl mercaptan, tertiary octyl mercaptan, tertiary nonyl mercaptan, tertiary lauryl mercaptan, tertiary tetradecyl mercaptan, tertiary hexadecyl mercaptan and the like, may be cited. Tertiary alkyl mercaptans having four carbon atoms or more can be used preferably. From the point of view of reducing the odors from PSA compositions and PSA sheets, it is advantageous to select tertiary alkyl mercaptans having six carbon atoms or more (more preferably 8 or more). Although the upper limit of the number of carbon atoms is not particularly set, it is typically 20 or less. For instance, tertiary lauryl mercaptan may be used preferably.

As another preferred example of non-corrosive mercaptan, mercaptans having a structure in which a mercapto group is bonded to a carbon atom constituting an aromatic ring or a heteroaromatic ring, that is to say, aromatic mercaptans, may be cited. For instance, aromatic mercaptans having about 6 to 20 carbon atoms, or heteroaromatic mercaptans having about 2 to 20 carbon atoms and containing a heteroatom, can be used preferably.

The aromatic mercaptans may be compounds having in at least one portion of the structure a bond between a structural moiety having aromaticity (typically, an aromatic ring) and a mercapto group, isomers thereof, or derivatives having a mercapto group. Examples of aromatic mercaptan include phenyl mercaptan, 4-tolyl mercaptan, 4-methoxyphenyl mercaptan, 4-fluorobenzene thiol, 2,4-dimethyl benzene thiol, 4-aminobenzene thiol, 4-fluorobenzene thiol, 4-chlorobenzene thiol, 4-bromobenzene thiol, 4-iodobenzene thiol, 4-t-butylphenyl mercaptan, 1-naphthyl mercaptan, 1-azulene thiol, 1-anthracene thiol, 4,4′ thiobenzene thiol, and the like.

The heteroaromatic mercaptans may be compounds having in at least one portion of the structure a bond between an aromatic ring containing a heteroatom (heteroaromatic ring) and a mercapto group, isomers thereof, or derivatives having a mercapto group. Examples of heteroaromatic mercaptan include 2-pyridyl mercaptan, 2-pyrrolyl mercaptan, 2-indolyl mercaptan, 2-furanyl mercaptan, 2-thiophene thiol, 2-benzothiophene thiol, 2-mercapto pyrimidine, and the like.

In one preferred mode of the art disclosed herein, the amount of non-corrosive mercaptan among the sulfur-containing chain transfer agents used for the synthesis of acrylic polymer is on the order of 60% by mass or greater, more preferably on the order of 75% by mass or greater, and even more preferably on the order of 90% by mass or greater. Essentially all of the sulfur-containing chain transfer agent may be a non-corrosive mercaptan. The non-corrosive mercaptan contained in the sulfur-containing chain transfer agent used in the art disclosed herein may be one species, two species or more. For instance, a chain transfer agent substantially comprising a tertiary lauryl mercaptan (may be a mixture of a plurality of structural isomers) can be used preferably.

The reason why the sulfur-containing gas emission of a PSA sheet may be efficiently decreased by the use of these non-corrosive mercaptans is inferred, for instance, as described below. An acrylic polymer synthesized in presence of a mercaptan may become one having as a residue of the mercaptan a structural moiety containing sulfur. It is thought that when this structural moiety undergoes a chemical change, it becomes a low molecular weight sulfur-containing gas and is eliminated from the acrylic polymer, which may be a factor causing a metal to corrode. However, with the non-corrosive mercaptan described above, it is thought that elimination of the sulfur-containing structural moiety from the acrylic polymer is unlikely to occur because the carbon atom adjacent to the sulfur is bonded to a bulky group, or an atom or a group having π electrons.

In one preferred mode of the art disclosed herein, as sulfur-containing chain transfer agents, those that generates essentially no sulfur-containing gas in the gas generation test described above (in other words, sulfur-containing chain transfer agents that do not contribute substantially to the amount of sulfur-containing gas generated in the test) are used. Such tertiary mercaptans (for instance, tertiary alkyl mercaptan) and aromatic mercaptans as described above are typical examples of materials that may be employed as sulfur-containing chain transfer agents that do not contribute substantially to the amount of sulfur-containing gas generated.

Regarding sulfur-containing chain transfer agents other than those described above, they can also be used as long as the preferred range of sulfur-containing gas emission disclosed herein is realized. As such chain transfer agents, mercaptans with structures having at least one mercapto group bonded to a primary carbon atom (hereafter also referred to as primary mercaptan) such as n-lauryl mercaptan, 2-mercaptoethanol, mercaptoacetic acid, thioglycolic acid-2-ethylhexyl and 2,3-dimercapto-1-propanol may be given as examples. However with a mode in which only primary mercaptans are to be used as chain transfer agents, realizing the desired adhesive capability while decreasing the sulfur-containing gas emission to the preferred range disclosed herein is difficult. Consequently, when a primary mercaptan is used, it is desirable to use it in combination with the non-corrosive mercaptan as described above or a mercaptan that does not contribute to the generation of sulfur-containing gas. Alternatively, essentially no primary mercaptans may be used.

Further, chain transfer agents with structures that do not contain sulfur as a structural element (sulfur-free chain transfer agents) may be used in addition to sulfur-containing chain transfer agents. For instance, α-methylstyrene dimer; terpenes such as a-pinene, limonene and terpinolene; and the like, can be used.

With emulsion polymerization thus carried out, a polymerization reaction mixture is produced resultantly in the form of an emulsion in which an acrylic polymer is dispersed in water. As the water-dispersed acrylic polymer in the art disclosed herein, this polymerization reaction mixture or the reaction mixture after a suitable work-up can be used preferably. Alternatively, a polymerization method other than the emulsion polymerization method (for instance, solution polymerization, photopolymerization, bulk polymerization, and the like) may be used to synthesize the acrylic polymer, and use a water-dispersed acrylic polymer prepared by dispersing this polymer in water.

Regarding preparation of the water-dispersed acrylic polymer, an emulsifier can be used as necessary. As emulsifiers, any of anionic, non-ionic and cationic ones can be used. In general, the use of an anionic or non-ionic emulsifier is preferred. Such emulsifiers can be used preferably, for instance, when a monomer constituent is to be emulsion-polymerized, when a resulting acrylic polymer produced by another method is to be dispersed in water, and the like.

As anionic emulsifiers, for instance, alkyl sulfate-type anionic emulsifiers such as sodium lauryl sulfate, ammonium lauryl sulfate and potassium lauryl sulfate; polyoxyethylene alkyl ether sulfate-type anionic emulsifiers such as sodium polyoxyethylene lauryl ether sulfate; polyoxyethylene alkyl phenyl ether sulfate-type anionic emulsifiers such as ammonium polyoxyethylene laurylphenyl ether sulfate and sodium polyoxyethylene laurylphenyl ether sulfate; sulfonate-type anionic emulsifiers such as sodium dodecylbenzene sulfonate; sulfosuccinic acid-type anionic emulsifiers such as disodium lauryl sulfosuccinate, disodium polyoxyethylene lauryl sulfosuccinate; and the like, may be cited.

As non-ionic emulsifiers, for instance, polyoxyethylene alkyl ether-type non-ionic emulsifiers such as polyoxyethylene lauryl ether; polyoxyethylene alkylphenyl ether-type non-ionic emulsifiers such as polyoxyethylene laurylphenyl ether; polyoxyethylene fatty acid ester; polyoxyethylene polyoxy propylene block polymer; and the like, may be cited. A radically polymerizing emulsifier (reactive emulsifier) with a structure comprising a radically polymerizing group (such as propenyl group) introduced into such an anionic or non-ionic emulsifier described above may also be used.

Of such emulsifiers, one species may be used alone or two or more species may be used in combination. The amount of emulsifier used suffices to be an amount used to allow an acrylic polymer to be prepared in the form of an emulsion, and is not limited in particular. For instance, selection from a range of, for instance, about 0.2 to 10 parts in mass (preferably about 0.5 to 5 parts in mass) based on solid content with respect to 100 parts in mass of acrylic co-polymer is adequate.

In addition to water-dispersed acrylic polymers, the PSA composition in the technique disclosed herein may further contain a tackifier resin. As tackifier resins, for instance, various tackifier resins such as rosinic, terpenic, hydrocarbon series, epoxy series, polyamide series, elastomer series, phenol series and ketone series can be used, with no particular limitation. Such tackifier resins may be used alone or in a combination of one, two species or more.

Concretely, as rosinic tackifier resins, for instance, native rosins (raw rosins) such as gum rosin, wood rosin and tall-oil rosin; modified rosins from the modification of these native rosins by hydrogenation, disproportionation, polymerization and the like (hydrogenated rosin, disproportionated rosin, polymerized rosin, other chemically modified rosins, and the like); other various rosin derivatives; and the like, may be cited. As rosin derivatives described above, for instance, rosin esters such as native rosins esterified with alcohols (that is to say, esters of rosin) and modified rosins (hydrogenated rosin, disproportionated rosin, polymerized rosin and the like) esterified with alcohols (that is to say, esters of modified rosin); unsaturated fatty acid-modified rosins comprising native rosins and modified rosins (hydrogenated rosin, disproportionated rosin, polymerized rosin and the like) modified with an unsaturated fatty acid; unsaturated fatty acid-modified rosin esters comprising rosin esters modified with an unsaturated fatty acid; rosin alcohols from the reductive treatment of a carboxyl group in native rosins, modified rosins (hydrogenated rosin, disproportionated rosin, polymerized rosin and the like), unsaturated fatty acid-modified rosins or unsaturated fatty acid-modified rosin esters; metal salts of rosins such as native rosin, modified rosin and various rosin derivatives (in particular, of rosin esters); rosin phenol resins resulting from the addition of phenol to rosins (native rosin, modified rosin, various rosin derivatives and the like) with an acid catalyst and heat polymerization; and the like, may be cited.

As terpenic tackifier resins, for instance, terpenic resins such as a-pinene polymer, β-pinene polymer and dipentene polymer; modified terpenic resins in which these terpenic resins have been modified (phenol modification, aromatic modification, hydrogenation modification, hydrocarbon modification and the like); and the like, may be cited. As the modified terpene resins described above, terpene-phenolic resin, styrene-modified terpenic resin, aromatized terpenic resin, hydrogenated terpenic resin and the like may be given as examples.

As hydrocarbon series tackifier resins, for instance, resins from various hydrocarbon series such as aliphatic hydrocarbon resin, aromatic hydrocarbon resin, aliphatic cyclic hydrocarbon resin, aliphatic/aromatic petroleum resin (styrene-olefin series co-polymers or the like), aliphatic/alicyclic petroleum resin, hydrogenated hydrocarbon resin, cumaron series resin and cumaron indene series resin may be cited. As aliphatic hydrocarbon resins, polymers of one, two or more kinds of aliphatic hydrocarbons selected fromolefins and dienes having about 4 to 5 carbons and the like may be given as examples. As examples of the olefins described above, 1-butene, isobutylene, 1-pentene and the like, may be cited. As examples of the dienes described above, butadiene, 1,3-pentadiene, isoprene and the like, may be cited. As aromatic series hydrocarbon resins, polymers of vinyl group-containing aromatic series hydrocarbon having about 8 to 10 carbons (styrene, vinyl toluene, a-methyl styrene, indene, methyl indene and the like), and the like, may be given as examples. As aliphatic series cyclic hydrocarbon resins, alicyclic hydrocarbon series resins polymerized after ring-forming dimerization of the so-called “petroleum C4 fraction” and “petroleum C5 faction”; polymers of cyclic diene compounds (cyclopentadiene, dicyclopentadiene, ethylidene norbornene, dipentene and the like) or hydrogen additives thereof; alicyclic hydrocarbon series resin from the hydrogenation of an aromatic ring in an aromatic series hydrocarbon resin or an aliphatic/aromatic series petroleum resin; and the like, may be given as examples.

In the art disclosed herein, tackifier resins having a softening point (softening temperature) on the order of 80° C. or higher (preferably on the order of 100° C. or higher) may be used preferably. According to such tackifier resins, PSA sheet of higher performance (for instance, of greater adhesive strength) may be realized. The upper limit of the softening point of the tackifier resin is not particularly set, but can be, for instance, on the order of 170° C. or lower (typically on the order of 160° C. or lower). Note that the softening point of the tackifier resin referred to herein is defined as the value measured according to the softening point test method (ring-and-ball method) established in JIS K 5902.

Such tackifier resins may be used preferably in the form of an emulsion in which the resin is dispersed in water. The tackifier resin emulsion described above may be prepared using an emulsifier, as necessary. As emulsifiers, one species or two species or more from similar ones to the emulsifiers that may be used for the preparation of a water-dispersed acrylic polymer can be selected suitably and used. In general, the use of an anionic emulsifier or a non-ionic emulsifier is preferred. Note that the emulsifier used for the preparation of the water-dispersed acrylic polymer and the emulsifier used for the preparation of the tackifier resin emulsion may be identical or may be differently. For instance, a mode in which an anionic emulsifier is used for the preparation of both emulsions, a mode in which a non-ionic emulsifier is used for both, a mode in which an anionic emulsifier is used on one and a non-ionic on the other, and the like, may be adopted preferably. The amount of emulsifier used is not limited in particular as long as the amount allows a tackifier resin to be prepared in the form of an emulsion, and for instance, can be selected from a range of about 0.2 to 10 parts in mass (preferably 0.5 to 5 parts in mass) with respect to 100 parts in mass of tackifier resin (based on solid content).

The amount of tackifier resin used is not limited in particular, and can be set suitably according to the target adhesive properties (adhesive strength or the like). For instance, the tackifier resin is preferably used at a proportion of about 10 to 100 parts in mass (more preferably 15 to 80 parts in mass, and even more preferably 20 to 60 parts in mass) in solid content criteria with respect to 100 parts in mass of acrylic polymer.

In the water-dispersed PSA composition described above, a crosslinking agent may be used, as necessary. The type of crosslinking agent is not limited in particular, and can be selected suitably from among crosslinking agents that are well known and in common use (for instance, isocyanate crosslinking agents, epoxy crosslinking agents, oxazoline crosslinking agents, aziridine series crosslinking agents, melamine crosslinking agents, peroxide crosslinking agents, urea crosslinking agents, metal alkoxide crosslinking agents, metal chelate crosslinking agents, metal salt crosslinking agents, carbodiimide crosslinking agents, amine crosslinking agents and the like) and used. As crosslinking agents used here, both oil-soluble and water-soluble can be used. A crosslinking agent can be used alone or by combining two species or more. The amount of crosslinking agent used is not limited in particular, and for instance, can be selected from a range of about 10 parts in mass or less (for instance, about 0.005 to 10 parts in mass, and preferably about 0.01 to 5 parts in mass) with respect to 100 parts in mass of acrylic polymer.

The PSA composition described above may contain, as necessary, an acid or a base (aqueous ammonia or the like) used for the purpose of pH adjustment or the like. As other optional constituents that may be included in the composition, various additives that are general in the field of water based PSA composition can be given as examples, such as viscosity adjuster (thickener or the like), leveling agent, release adjuster, plasticizer, softener, filler, colorant (pigment, dye and the like), surfactant, anti-electrostatic agent, antiseptic agent, anti-aging agent, UV absorber, antioxidant and light stabilizer.

The PSA layer in the art disclosed herein can be formed suitably by conferring such a water-dispersed PSA composition as described above onto a prescribed surface and drying or curing. When conferring a PSA composition (typically coating), coaters that are in common use (for instance, gravure roll coater, reverse roll coater, kiss roll coater, dip roll coater, bar coater, knife coater, spray coater and the like) can be used. The thickness of the PSA layer is not limited in particular, and it may be for instance about 2 μm to 200 μm (preferably about 5 μm to 100 μm).

The double-sided PSA sheet provided with such a PSA layer may be produced by a variety of methods. For instance, a method whereby a PSA composition is directly conferred to each side of a substrate, dried or cured to form PSA layers, and a release liner is layered on each of these PSA layers; a method whereby a PSA layer formed on a release liner is laminated to each side of a substrate, and while each PSA layer is transferred to the substrate the release liners are used as-is for protecting the PSA layers; and the like, may be adopted. In addition, different methods may be adopted between the first side and the second side of the substrate.

In the PSA sheet disclosed here, as substrate for supporting (backing) the PSA layer, for instance, plastic films such as polyolefin (polyethylene, polypropylene, ethylene-propylene co-polymer and the like) film, polyester (polyethylene terephthalate or the like) film, polyvinyl chloride resin film, vinyl acetate resin film, polyimide resin film, polyamide resin film, fluoro resin film and other cellophanes can be used. The plastic films described above may be of the non-stretched type or may be of the stretched type (uniaxially stretched-type or biaxially stretched-type). The substrate may have a single layer configuration or a multi-layer configuration.

As particularly desirable substrates, polyester films are given as examples. Polyester films are desirable from such points of views as dimensional stability, economy (costs), processability and tensile strength. As polyester films, a variety of films comprising a resin material having polyester as the main constituent formed into a film-shape can be used. Here, polyester refers to a polycondensate between a multivalent carboxylic acid and a poly alcohol (typically, a dicarboxylic acid and a diol). As preferably used polyesters, polyethylene terephthalate (PET), polyethylene naphthalate (PEN) and the like are given as examples. Among these, the use of a PET film is desirable.

As the above substrate, it is desirable that when the Young's modulus of the substrate is Y (kPa) and the thickness is h (mm), the bending elasticity coefficient E represented by the mathematical formula (A): E=Yh³; is about 5×10⁴ or less (more preferably 0.001 or greater and 4.5×10⁴ or less, and further preferably 0.01 or greater and 4×10⁴ or less). If the elasticity coefficient E is excessively higher than the above range, sometimes the ability, when attached onto a binding surface presenting a curvature or a step, of conforming to the binding surface (curved-surface-conformability) decreases, making the sheet likely to being peeled off. Note that the value measured according to ASTM D882 is adopted as the Yung's modulus Y referred to here.

As the above substrate, one with a breaking strength of preferably on the order of 130 MPa or greater and 500 MPa or less (more preferably on the order of 140 MPa or greater and 480 MPa or less, and further preferably on the order of 150 MPa or greater and 460 MPa or less) is used. This makes the PSA sheet to be less likely to be torn or stretched at processing time or attaching time. Consequently, a double-sided PSA sheet may be realized, which is also suitable for the bonding or the like of parts in various electronic devices such as household appliances and OA equipment. If the breaking strength is excessively lower than the above range, sometimes tearing or stretching occurs on the PSA sheet when attaching, decreasing handleability. If the breaking strength is excessively higher than the above range, sometimes the ability, when attached on a curved surface, of conforming to the curved surface (contour-following ability) decreases, making the sheet likely to being peeled off. Note that the breaking strength referred to here is defined as the value measured with respect to the flow direction (MD) according to JIS C 2151.

In addition, it is desirable that elongation at break is about 50% or greater and 300% or less (more preferably about 60% or greater and 270% or less, and further preferably 70% or greater and 250% or less). This may form a double-sided PSA sheet having excellent curved-surface-conformability and high dimensional stability. Consequently, a double-sided PSA sheet may be realized, which is also suitable for the bonding or the like of parts in various electronic devices such as household appliances and OA equipment. If the elongation at break is excessively lower than the above range, sometimes the curved-surface-conformability decreases. If the elongation at break is excessively higher than the above range, sometimes issues such as stretching are likely to occur at attaching time, making the sheet more difficult to handle. Note that the elongation at break referred to here is defined as a value measured with respect to the flow direction (MD) according to JIS C 2151.

Note that, while the thickness of the above-mentioned substrate is not limited in particular and can be selected suitably according to the purpose, it is generally in the range of about 1 μm to 500 μm.

As necessary, various additives may be mixed in the substrate described above, such as fillers (inorganic fillers, organic fillers and the like), anti-aging agent, antioxidant, UV absorber, anti-electrostatic agent, lubricant, plasticizer, colorant (pigment, dye and such). A surface treatment that is well known or in common use may have been carried out on the surface of the substrate (in particular, the surface on the side where the PSA layer is to be provided), such as, for instance, corona discharge treatment, plasma treatment ITRO treatment and coating of an undercoat. Such surface treatments may be treatments for the purpose of increasing, for instance, the substrate anchoring ability of the PSA layer.

As undercoat agent, for instance, a water dispersion solution of a compound having an oxazoline group can be used. The undercoat layer may be formed by conferring such an undercoat agent to a substrate and then drying at an appropriate temperature. It is desirable that the thickness of the undercoat layer is about 0.001 μm or greater but less than 3 μm (preferably 0.01 μm to 2 μm, and more preferably 0.03 μm to 1 μm). These surface treatments may be carried out with one species alone or by combining two or more species. For instance, it is possible to confer an undercoat layer on a substrate treated by corona discharge.

As commercially available products usable in forming an oxazoline undercoat layer, product name “EPOCROS WS-500” manufactured by Nippon Shokubai Co., LTD., idem “EPOCROS WS-700”, idem “EPOCROS K-1000” series, idem “EPOCROS K-2000” series, idem “EPOCROS K-3000” series, and the like are given as examples.

It is desirable that the contact angle of water on the substrate surface is 0 degrees or greater and 90 degrees or less (for instance, 0 degrees or greater and 88 degrees or less). In general, the above-mentioned contact angle is preferably 30 degrees or greater and 90 degrees or less, and more preferably 50 degrees or greater and 90 degrees or less. The contact angle may also be 80 degrees to 90 degrees. The substrate may be selected so as to realize such a contact angle, or alternatively, a surface treatment such as one described above can be performed as necessary.

Note that the substrate surface that is the subject of measurement of water contact angle here is a surface over which a PSA layer has been formed. Consequently, for instance, with a substrate subjected to a surface treatment such as one described above, the water contact angle is measured on the substrate surface after the surface treatment has been carried out.

While the thickness of the substrate can be selected suitably according to the purpose, it is generally about 10 μm to 500 μm, and preferably about 1 μm to 300 μm (more preferably 1 μm to 250 μm, and further preferably 1 μm to 200 μm). If the substrate is excessively thicker than the above-mentioned range, sometimes there is a possibility that the curved-surface-conformability is insufficient, and if excessively thin, issues sometimes arise, such as, decrease in handleability of the PSA sheet, and tearing of the PSA sheet when being peeled off from the adherend.

As release liners protecting or supporting the PSA layer (may be one that combine the functions of protection and support), those that are suitable can be selected from well known release liners and used, the materials and the constitution thereof not being limited in particular. For instance, a release liner having a constitution in which at least one surface of the substrate has been subjected to release treatment (typically, provided with a release layer by a release treatment agent) can be used suitably. As substrates for constituting this type of release liner (subjects of release treatment), substrates similar to those described above, various plastic films, papers, fabrics, rubber sheets, foam sheets, metal foils, composites thereof and the like can be selected suitably and used. As release treatment agents for forming the release treatment layer described above, release treatment agents that are well known or in common use (for instance, release treatment agent such as from the silicone series, fluorine series and long chain alkyl series) can be used. In addition, substrates having low adhesive properties comprising fluoropolymers (for instance, polytetrafluoroethylene, polychlorotrifluoroethylene, polyvinylfluoride, polyvinylidenefluoride, tetrafluoroethylene-hexafluoropropylene co-polymer, chlorofluoroethylene-vinylidenefluoride co-polymer and the like) or low polarity polymers (for instance, olefin series resins such as polyethylene and polypropylene, and the like) may be used as release liners on the surface of the substrate without performing a release treatment. Alternatively, such a low adhesive property substrate with a release treatment performed on the surface may be used as a release liner.

The thickness of the substrate or the release layer constituting the release liner is not limited in particular, and can be selected suitably according to the purpose or the like. The total thickness of the release liner (for a release liner with a constitution having a release layer on the substrate surface, the entire thickness including the substrate and the release layer) is, for instance, preferably on the order of 15 μm or greater (typically about 15 μm to 500 μm), and more preferably about 25 μm to 500 μm.

In addition, if crosslinking is carried out when forming the PSA layer, it can be carried out in a prescribed production process according to the species of the crosslinking agent (for instance, the heat crosslinking type crosslinking agent, which crosslinks by heat, the light crosslinking type, which crosslinks by UV illumination) by crosslinking methods that are well known and in common use. For instance, when a crosslinking agent of the heat crosslinking type is used, crosslinking can be carried out after coating with the water-dispersed acrylic PSA, when drying, by letting the heat-crosslinking reaction to proceed in parallel or simultaneously to this drying. Concretely, crosslinking can be carried out along with drying, by heating, according to the species of the heat-type crosslinking agent, at a temperature at which the crosslinking reaction proceeds, or higher.

In the art disclosed herein, although the amount of solvent-insoluble fraction (crosslinked body of acrylic polymer) in the PSA constituting the PSA layer is not limited in particular, in general, it is preferably for instance about 15 to 70% by mass of the entire PSA layer. The solvent-insoluble fraction described above indicates the proportion in mass of the insoluble fraction that remains when the post-crosslinking PSA has been extracted with ethyl acetate. In addition, in this case, the weight average molecular weight of the solvent-soluble fraction of the PSA (acrylic polymer resulting from the extraction of the PSA with tetrahydrofuran) is preferably in a range of, for instance, 10×10⁴ to 200×10⁴ (preferably about 20×10⁴ to 160×10⁴) as a value converted into polystyrene in a gel permeation chromatography (GPC) method. This weight average molecular weight can be measured with a general GPC device (for instance, GPC device manufactured by TOSOH; model: HLC-8120GPC; column used: TSKgel GMH-H(S)). Note that, the proportion of the solvent-insoluble fraction and the weight average molecular weight of the solvent-soluble fraction described above can be set arbitrarily by adjusting suitably, for instance, the amount of functional group-containing monomerwith respect to the total amount of monomers, the types of the chain transfer agent and the amount thereof, the species of the crosslinking agent and the amount thereof, and the like.

The PSA sheet disclosed here is characterized by a sulfur-containing gas emission of 0.043 μg SO₄²⁻/cm² or less (preferably 0.03 μg SO₄²⁻/cm² or less) in a gas generation test in which the PSA sheet is heated at 85° C. for one hour. From the point of view of non-corrosive properties to metal, it is desirable that the sulfur-containing gas emission from the PSA sheet is an as low a value as possible below the value described above. Therefore, as constitutive materials of the PSA sheet disclosed here and as materials used in the production process therefore, it is desirable that the use of materials which may become a source of sulfur-containing gas generation is avoided or the amount thereof used is minimized, not only for the chain transfer agent used in the synthesis of the acrylic polymer but also for the other materials. For instance, for materials other than the chain transfer agent used in the synthesis of the acrylic polymer (emulsifier, polymerization initiator and the like), tackifier resin, emulsifier and other various additives that may be included in the tackifier resin emulsion, crosslinking agent, various additives that may be mixed in the water-dispersed PSA composition, substrate for PSA sheet and additives therefor, and the like, it is desirable to select those in which generation of sulfur-containing gas is unlikely to occur. This allows the non-corrosive properties of the PSA sheet to be increased all the more while using a sulfur-containing chain transfer agent to maintain a satisfactory adhesive properties. In one preferred mode, in the gas generation test described above, the fraction within the sulfur-containing gas emission from the PSA sheet contributed by materials other than the chain transfer agent (that is to say, the amount of sulfur-containing gas generated originating from materials other than the chain transfer agent) is essentially zero.

In one preferred mode of the double-sided PSA sheet disclosed here, in the gas generation test described above, the fraction within the sulfur-containing gas emission from the double-sided PSA sheet contributed by the sulfur-containing chain transfer (that is to say, the amount of sulfur-containing gas generated originating from the sulfur-containing chain transfer agent) is 0.03 μg SO₄²⁻/cm² or lower (more preferably less than 0.02 μg SO₄²⁻/cm²). According to such mode, keeping the total amount of sulfur-containing gas released from the double-sided PSA sheet to 0.043 μg SO₄²⁻/cm² or lower is facilitated. For instance, this is desirable as there are broader choices of materials for the sulfur-containing chain transfer agent and the amount thereof used. In one preferred mode, the amount of sulfur-containing gas generated originating from the sulfur-containing chain transfer agent is essentially zero (typically less than 0.02 SO₄²⁻/cm²).

The art disclosed herein may be applied to corrosion prevention of various metals that may react with a sulfur-containing gas (H₂S, SO₂ and the like) and deteriorate (such as formation of sulfide). As such metals which are targets of corrosion, transition metals such as silver, copper, titanium, chromium, iron, cobalt, nickel and zinc; metals belong to the typical elements such as aluminum, indium, tin and lead; and the like, may be cited. Due to being prone to corrosion by a sulfur-containing gas and being widely used as constitutive materials for base boards and wirings, silver and silver alloys (alloys having silver as the main constituent) may be cited as particularly desirable corrosion prevention subject metal. According to one preferred mode of the double-sided PSA sheet disclosed here, metal corrosion may be prevented, such that, when 1.0 g of the PSA sheet (including the PSA layer and the substrate but not including the release liner) and a silver plate are placed in a non-contacting state inside a sealed space of 50 mL in volume and kept at 85° C. for one week, no alteration in the appearance indicative of corrosion (for instance, decrease or disappearance of metal sheen, coloration such as blackening) is observed on the above silver plate by visual inspection.

According to the double-sided PSA sheet disclosed here, the emission of sulfur-containing gas is highly suppressed as described above, which ensures that corrosion of metal and issues associated thereto (contact defects, decrease in quality of appearance) can be prevented or suppressed. Therefore, PSA sheet described above can be used preferably inside the housings of, for instance, televisions (liquid crystal televisions, plasma televisions, cathode-ray tube televisions and the like), computers (display, main body and the like), sound equipments, other various home appliances, OA equipment and the like, for purposes such as binding parts, sealing gaps (seals), and buffering vibrations and impacts. In particular, it is suitable as a PSA sheet for use in an environment where the generation of sulfur-containing gas and corrosion of metal are readily promoted due to the temperature rising inside the housing facilitated by the use of electronics (such as inside the housing of a liquid crystal television). According to the PSA sheet disclosed here, metal corrosion may be highly prevented even in such a mode of use.

The double-sided PSA sheet disclosed here may demonstrate, along with high levels of metal corrosion prevention properties, excellent adhesive properties as it is provided with a PSA layer formed from a PSA composition containing a water-dispersed acrylic polymer, with a sulfur-containing chain transfer agent being used in the synthesis of acrylic polymer described above. Consequently, such a PSA sheet may be used preferably as a double-sided PSA sheet for binding parts where great adhesive properties (for instance adhesive strength) are required, inside an electronic device and other locations. With a double-sided PSA sheet, thorough adhesion to the substrate to form the PSA layer is important; in addition, from the tendency of being required high adhesive properties, it is particularly significant that the molecular weight may be adjusted by using a sulfur-containing chain transfer agent. Although not to be limited in particular, the thickness of a PSA layer constituting a double-sided PSA sheet may be, for instance, about 20 μm to 150 μm per side.

According to the art disclosed herein, a double-sided PSA sheet for which the adhesive strength against a stainless plate (SUS: BA304) (may be understood by the adhesiveness measurement described below) is about 1.5N/20 mm or greater (typically 1.5N to 20N/20 mm or greater) may be provided. According to a preferred mode, PSA sheet for which the adhesive strength described above is about 3N/20 mm or greater (more preferably about 4N/20 mm or greater, for instance 5N/20 mm or greater) may be provided. In addition, according to the art disclosed herein, a double-sided PSA sheet may be provided, which demonstrates a cohesive strength (may be understood by the cohesive strength measurement described below) to an extent that, when bonded to a phenol resin plate, the shift distance after one hour at 40° C. is less than 20 mm. According to a preferred mode, double-sided PSA sheet may be provided demonstrating a cohesive strength to an extent that the shift distance described above is less than 15 mm (more preferably less than 10 mm, for instance less than 1 mm). A double-sided PSA sheet that satisfies both the adhesiveness and the cohesive strength described above is desirable.

In one preferred mode of the double-sided PSA sheet disclosed herein, when the PSA sheet is heated at 80° C. for 30 minutes, no toluene is emitted, or toluene emission (hereinafter, may be referred to as simply “toluene emission”) is 20 μg or less per 1 g of the PSA sheet (hereafter, this may be noted as “20 μg/g” or the like).

Note that the value worked out by the following toluene emission measurement method is adopted as the toluene emission.

### [Toluene Emission Measurement Method]

A pre-determined size (surface area: 5 cm²) is cut out from each double-sided PSA sheet to prepare a sample, and the sample is introduced into a vial bottle and sealed. Thereafter, the vial bottle with the introduced sample is heated at 80° C. for 30 minutes, 1.0 mL of gas in heated state is transferred with a headspace auto sampler to a gas chromatograph measurement apparatus (GC measurement apparatus) to measure the amount of toluene, and the toluene content (emission) per 1 g of sample (double-sided PSA sheet) [μg/g] is calculated and quantified.

Note that the mass of the double-sided PSA sheet, which is the reference for calculating the toluene content per 1 g of double-sided PSA sheet, is the mass of the entirety of the substrate and the PSA layer provided on each side of the substrate, and does not contain the mass of the release liner.

In another preferred mode of the double-sided PSA sheet disclosed herein, when the PSA sheet is heated at 80° C. for 30 minutes, no ethyl acetate is emitted, or ethyl acetate emission (hereinafter, may be referred to as simply “ethyl acetate emission”) is 20 μg or less per 1 g of the PSA sheet (hereafter, this may be noted as “20 μg/g” or the like).

Note that the value resulted from the measurement of ethyl acetate emission according to the above toluene emission measurement method is adopted as the ethyl acetate emission.

In addition, in another preferred mode, the total emission of volatile organic compounds (VOC) when the double-sided PSA sheet is heated at 80° C. for 30 minutes (hereafter also called “TVOC amount”) is 500 μg or less per 1 g of the PSA sheet.

Note that the value worked out by the following TVOC amount measurement method is adopted as the TVOC amount.

### [TVOC Amount Measurement Method]

A vial bottle with a sample introduced, which was prepared in a similar manner to the above toluene emission measurement method, is heated at 80° C. for 30 minutes, and 1.0 mL of gas in heated state is transferred with a headspace auto sampler to a GC measurement apparatus. The TVOC amount per 1 g of the sample (PSA sheet) [μg/g] is determined based on the resulting gas chromatogram by performing peak assignment and quantification with a calibrator for the volatile substances anticipated from the materials used in the preparation of the PSA composition (residual monomer and solvents or the like contained in a tackifier resin emulsion), and by quantifying as toluene conversion for the other peaks (for which assignment is difficult).

Note that the mass of the double-sided PSA sheet, which is the reference for calculating the TVOC amount per 1 g of double-sided PSA sheet, is the mass of the entirety of the substrate and the PSA layer provided on each side of the substrate, and does not contain the mass of the release liner.

Note that, the conditions for the gas chromatograph for all of the measurements of toluene emission, ethyl acetate emission and TVOC amount mentioned above are as follows.
Column: DB-FFAP 1.0 μm (0.535 mm diameter×30 m)
Carrier gas: He 5.0 mL/min
Column head pressure: 23 kPa (40° C.)
Injection port: split (split ratio=12:1; temperature=250° C.)
Column temperature: 40° C. (0 min)-<+10° C./min>−250 (9 min) [meaning, from 40° C., heating to 250° C. at a rate of temperature rise of 10° C./min, and then holding at 250° C. for 9 minutes]
Detector: FID (temperature=250° C.)

A double-sided PSA sheet for which one, two or more among toluene emission, ethyl acetate emission and TVOC amount demonstrate the preferred characteristics described above may be used suitably in a variety of fields including fields in which a high degree of reduction in VOC is sought. For instance, it is suitable to applications in which the PSA sheet is used in a closed space, more concretely, materials for cars (typically, automobiles) such as car interiors, and application for immobilizing home materials such as home building materials.

Hereafter, a number of examples according to the present invention will be described; however, the present invention is not intended to be limited to those indicated in examples. Note that in the following description, mass is the criteria for “part” and “%” unless expressly indicated otherwise.

### Example 1

Into a reaction vessel equipped with a condenser, a nitrogen inlet tube, a thermometer and a stirrer, 30 parts of ion-exchanged water was introduced, and the reaction vessel was purged with nitrogen gas by stirring at 60° C. for one hour or longer under nitrogen gas flow. To this reaction vessel, 0.1 parts of 2,2′-azobis[N-(2-carboxyethyl)-2-methylpropionamidine]hydrate (polymerization initiator) (product name “VA-057”, a product manufactured by Wako Pure Chemical Industries, Ltd.) was added. While maintaining the system at 60° C., a monomer emulsion was added therein dropwise gradually over four hours to proceed with the emulsion polymerization reaction. As for the monomer emulsion, 70 parts of butylacrylate, 25 parts of 2-ethylhexylacrylate, 5 parts of acrylic acid, 0.03 parts of tertiary butyl mercaptan (chain transfer agent) and 1.5 parts (converted into solid content) of polyoxyethylene sodium lauryl sulfate (emulsifier) added to 70 parts of ion-exchanged water and emulsified was used. After the dropwise addition of the monomer emulsion was finished, the system was further maintained at 60° C. for three hours, and 0.075 parts of hydrogen peroxide water and 0.15 parts of ascorbic acid were added to synthesize a water-dispersed acrylic polymer. The resulting polymerization reaction mixture above was cooled to room temperature and then the pH was adjusted to 7 by the addition of 10% aqueous ammonia. Converted into solid content, with respect to 100 parts of this reaction solution, 20 parts of product name “TAMANOL E-100” (a tackifier containing a terpene phenol resin) manufactured by Arakawa Chemical Industries, Ltd. was added to obtain the water-dispersed acrylic PSA composition according to the present example.

The above PSA composition was coated in such a way that the thickness after drying became 60 μm over a first side of a 23 μm-thick PET film substrate (product name “LUMIRROR S10”, manufactured by Toray Industries, Inc.) treated by corona discharge on each side, and dried at 120° C. for 3 minutes to form a PSA layer. The heavy release side (the side that has been weakly release-treated compared to the other side) of a release liner, each side of which being a release side that had been release-treated with a silicone release agent, was laminated on this PSA layer. Next, a PSA layer was also formed on the second side of this substrate (the side on the opposite side of the first side) in a similar manner to the first side, and a release liner was laminated to prepare a double-sided PSA sheet.

### Example 2

Into a reaction vessel equipped with a condenser, a nitrogen inlet tube, a thermometer and a stirrer, 30 parts of ion-exchanged water was introduced, and the reaction vessel was purged with nitrogen gas by stirring at 60° C. for one hour or longer under nitrogen gas flow. To this reaction vessel, 0.3 parts of ammonium persulfate was added. While maintaining the system at 60° C., a monomer emulsion was added therein dropwise gradually over four hours to proceed with the emulsion polymerization reaction. As for the monomer emulsion, 80 parts of butylacrylate, 15 parts of 2-ethylhexylacrylate, 3 parts of acrylic acid, 2 parts of methacrylic acid, 0.05 parts of 3-methacryloxy propyltrimethoxysilane (product name “KBM-503”, a product of Shin-Etsu Chemical Co., Ltd.), 0.05 parts of tertiary lauryl mercaptan (chain transfer agent) (“tertiary lauryl mercaptan”, manufactured by Tokyo Chemical Industry Co., Ltd.) and 1.5 parts (converted into solid content) of polyoxyethylene ammonium lauryl ether sulfate (emulsifier) (product name “HITENOL LA-16”, manufactured by Dai-Ichi Kogyo Seiyaku Co., LTD.) added to 70 parts of ion-exchanged water and emulsified was used. After the dropwise addition of the monomer emulsion was finished, the system was further maintained at 60° C. for three hours, and 0.075 parts of hydrogen peroxide water and 0.15 parts of ascorbic acid were added to synthesize a water-dispersed acrylic polymer. The resulting polymerization reaction mixture above was cooled to room temperature and then the pH was adjusted to 7 by the addition of 10% aqueous ammonia. Converted into solid content, with respect to 100 parts of this reaction solution, 20 parts of product name “SUPER ESTER E-720” (a water-dispersed tackifier containing stabilized rosin ester) manufactured by Arakawa Chemical Industries, Ltd. was added to obtain the water-dispersed acrylic PSA composition according to the present example.

Over a first side of a 50 μm-thick PET film substrate (product name “LUMIRROR S10”, manufactured by Toray Industries, Inc.) treated by corona discharge on each side, product name “EPOCROS K-2020E” (an acrylic emulsion containing an oxazoline group) manufactured by Nippon Shokubai Co., LTD. was coated as an undercoat agent in such a way that the thickness after drying became 1.0 μm, and dried at 100° C. to form an undercoat layer. Similarly, an undercoat layer was formed on the second side of the substrate as well. Over the undercoat layer of the substrate first side, the above PSA composition was coated in such a way that the thickness after drying became 50 μm, and dried at 120° C. for 3 minutes to form a first PSA layer. The heavy release side of the same release liner as that used in Example 1 was laminated to this first PSA layer. In a similar manner to the first side, a second PSA layer was formed over the undercoat layer of the substrate second side as well, and a release liner was laminated to prepare a double-sided PSA sheet.

### Example 3

Into a reaction vessel equipped with a condenser, a nitrogen inlet tube, a thermometer and a stirrer, 30 parts of ion-exchanged water was introduced, and the reaction vessel was purged with nitrogen gas by stirring at 60° C. for one hour or longer under nitrogen gas flow. To this reaction vessel, 0.1 parts of 2,2′-azobis[N-(2-carboxyethyl)-2-methylpropionamidine]hydrate (polymerization initiator) (product name “VA-057”, a product manufactured by Wako Pure Chemical Industries, Ltd.) was added. While maintaining the system at 60° C., a monomer emulsion was added therein dropwise gradually over four hours to proceed with the emulsion polymerization reaction. As for the monomer emulsion, 70 parts of butylacrylate, 25 parts of 2-ethylhexylacrylate, 5 parts of acrylic acid, 0.05 parts of 3-methacryloxy propyltrimethoxysilane (a product of Shin-Etsu Chemical Co., Ltd., product name “KBM-503”), 0.03 parts of phenyl mercaptan (chain transfer agent), and 1.5 parts (converted into solid content) of polyoxyethylene sodium lauryl ether sulfate added to 70 parts of ion-exchanged water and emulsified was used. After the dropwise addition of the monomer emulsion was finished, the system was further maintained at 60° C. for three hours, and 0.075 parts of hydrogen peroxide water and 0.15 parts of ascorbic acid were added to synthesize a water-dispersed acrylic polymer. The resulting polymerization reaction mixture above was cooled to room temperature and then the pH was adjusted to 7 by the addition of 10% aqueous ammonia. Converted into solid content, with respect to 100 parts of this reaction solution, 20 parts of product name “TAMANOL E-100” (a tackifier containing a terpene phenol resin) manufactured by Arakawa Chemical Industries, Ltd. was added to obtain the water-dispersed acrylic PSA composition according to the present example.

Over a first side of a 23 μm-thick PET film substrate (product name “LUMIRROR S10”, manufactured by Toray Industries, Inc.) treated by corona discharge on each side, product name “EPOCROS K-2020E” (an acrylic emulsion containing an oxazoline group) manufactured by Nippon Shokubai Co., LTD. was coated as an undercoat agent in such a way that the thickness after drying became 0.1 μm, and dried at 100° C. to form an undercoat layer. The substrate second side is also provided with an undercoat layer. Over the undercoat layer of the substrate first side, the above PSA composition was coated in such a way that the thickness after drying became 60 μm, and dried at 120° C. for 3 minutes to form a first PSA layer. The heavy release side of the same release liner as that used in Example 1 was laminated to this first PSA layer. In a similar manner to the first side, a second PSA layer was formed over the undercoat layer of the substrate second side as well, and a release liner was laminated to prepare a double-sided PSA sheet.

### Example 4

In the present example, 0.05 parts of tertiary lauryl mercaptan (product name “tertiary lauryl mercaptan”, manufactured by Tokyo Chemical Industry Co., Ltd.) was used instead of the tertiary butyl mercaptan of Example 1. In a similar manner to Example 1 regarding the other points, a water-dispersed acrylic PSA composition was produced. A double-sided PSA sheet was prepared in a similar manner to Example 1, except that this PSA composition and a 2 μm-thick PET film substrate (product name “LUMIRROR S10”, manufactured by Toray Industries, Inc.) treated by corona discharge on each side, were used.

### Example 5

In the present example, double-sided PSA sheet was prepared in a similar manner to Example 1, except that the PSA composition of Example 4 and a 188 μm-thick PET film substrate (product name “LUMIRROR S10”, manufactured by Toray Industries, Inc.) treated by corona discharge on each side, were used.

### Example 6

In the present example, 0.05 parts of n-lauryl mercaptan was used instead of the tertiary butyl mercaptan of Example 1. In a similar manner to Example 1 regarding the other points, a water-dispersed acrylic PSA composition was produced. A double-sided PSA sheet was prepared in a similar manner to Example 1, except that this PSA composition was used.

### Example 7

In the present example, a double-sided PSA sheet was prepared in a similar manner to Example 1, except that a 250 μm-thick PET film substrate (product name “LUMIRROR S10”, manufactured by Toray Industries, Inc.) treated by corona discharge on each side, were used instead of the substrate of Example 1.

### Example 8

In the present example, a double-sided PSA sheet was prepared in a similar manner to Example 1, except that a 342 μm-thick PET film substrate (product name “LUMIRROR S10”, manufactured by Toray Industries, Inc.) treated by corona discharge on each side, were used instead of the substrate of Example 1.

### Example 9

Into a reaction vessel equipped with a condenser, a nitrogen inlet tube, a thermometer and a stirrer, 95 parts of butylacrylate, 5 parts of acrylic acid, 0.01 parts of tertiary butyl mercaptan (chain transfer agent), and 150 parts of toluene were introduced, the interior of the reaction vessel was purged with nitrogen gas by stirring gently under nitrogen gas flow. This reaction solution was heated to 60° C., and 0.1 parts of 2,2′-azo-bis-isobutyronitrile (polymerization initiator) was added. While maintaining the system at 63° C., polymerization reaction was carried out for seven hours to synthesize an acrylic polymer. The weight average molecular weight of this acrylic polymer was 4.5×10⁵. Converted into solid content, with respect to 100 parts of this reaction solution, 30 parts of product name “NIKANOL H-80” (a xylene formaldehyde series tackifier resin containing a hydroxyl group manufactured by Mitsubishi Gas Chemical Company, Inc.), 0.05 parts of product name “EDP-300” (a hydroxy compound containing a nitrogen atom manufactured by Adeka Corporation (former Asahi Denka), and 4 parts of product name “CORONATE L” (an isocyanate compound manufactured by Nippon Polyurethane Industry Co., LTD.) were added and thoroughly mixed to obtain the PSA composition according to the present example.

Over a first side of a 23 μm-thick PET film substrate (product name “LUMIRROR S10”, manufactured by Toray Industries, Inc.) untreated on both sides, this PSA composition was coated in such a way that the thickness after drying became 60 μm, and dried at 110° C. for 3 minutes to form a first PSA layer. The heavy release side of the same release liner as that used in Example 1 was laminated to this first PSA layer. In a similar manner to the first side, on the second side of the substrate, a second PSA layer was formed and a release liner was laminated to prepare a double-sided PSA sheet.

### Example 10

In the present example, an acrylic polymer was synthesized in a similar manner to Example 8, except that 250 parts of ethyl acetate was used instead of the 150 parts of toluene of Example 9. The weight average molecular weight of the resulting acrylic polymer was 7.0×10⁵.

A double-sided PSA sheet was prepared in a similar manner to Example 9 except that this reaction solution was used.

### Example 11

In the present example, a double-sided PSA sheet was prepared in a similar manner to Example 1 except that a 23 μm-thick PET film substrate (product name “LUMIRROR S10” manufactured by Toray Industries, Inc.) untreated on both sides was used instead of the substrate of Example 1.

For each resulting PSA sheet above, the following measurement or evaluation was carried out. The results are shown in Tables 1 and 2. Shown together in Table 1 are the types of chain transfer agents used in each example, and in Table 2, the characteristics of the plastic film substrate (thickness, Young's modulus, bending elasticity coefficient, breaking strength and elongation at break). Note that measurements of toluene emission, ethyl acetate emission and TVOC amount were carried out respectively by the methods described above.

<Adhesiveness Measurement>

The first release liner (the release liner protecting the PSA layer provided on the first side of the substrate) of a double-sided PSA sheet was peeled off and a 23 μm-thick PET film was adhered for backing. This backed PSA sheet cut into a size of 20 mm in width and 100 mm in length served as a test piece. The second release liner of the test piece was peeled off, which was pressure-bonded to a stainless (SUS: BA304) plate with a 2 kg roller traveling back and forth once. This was stored at 23° C. for 30 minutes, then, 180°-peel strength (adhesive strength) was measured using a tensile tester, in a measurement environment of 23° C. temperature and 50% RH, at a pull speed of 300 mm/minute, in accordance with JIS Z 0237.

<Measurement of Sulfur-Containing Gas Emission>

Approximately 0.1 g of each PSA sheet of which the release liner was peeled off from each adhesive surface was placed on a furnace sample boat and heated at 85° C. for one hour using a furnace (automatic sample furnace manufactured by Dia Instruments Co., Ltd., model “AQF-100”). The gas generated from the PSA sheet in so doing was passed through 10 mL of an absorption solution. This absorption solution comprised 30 ppm hydrogen peroxide in pure water, allowing the sulfur-containing gas (H₂S, SO₂ and the like) that may be included in the generated gas described above to be converted into SO₄²⁻ and collected. The absorption solution after passage of the generated gas was added with pure water to adjust the volume to 20 mL, and the amount of SO₄²⁻ generated per 1 g of PSA sheet was determined by carrying out a quantitative analysis of SO₄²⁻ using an ion chromatograph (manufactured by Dionex; product name: DX-320). Note that similar operations were carried out with the sample boat described above in an empty state, which served as blank. The results were converted into amounts of SO₄²⁻ generated per surface area of each PSA sheet. These results are shown in Table 1.

### [Automatic Sample Furnace Operating Conditions]

Temperature: Inlet=85° C.; Outlet=85° C.
Gas flow rate: O₂=400 mL/minute; Ar (water sending unit: 0 graduation)=150 mL/minute

### [Conditions for Measurements by (Anionic) Ion Chromatograph]

Separation column: IonPac AS18 (4 mm×250 mm)
Guard column: IonPac AG18 (4 mm×50 mm)
Removal system: ASRS-ULTRA (external mode, 75 mA)
Detector: electric conductivity detector
Eluents: 13 mM KOH (0 to 20 minutes)
   30 mM KOH (20 to 30 minutes)
   (eluent generator EG40 used)
Eluent flow rate: 1.0 mL/minute
Sample injection amount: 250 μL

<Metal Corrosivity Test>

Readying 1.0 g of each PSA sheet (comprising a substrate and a PSA layer provided on each side thereof) of which the release liner was peeled off from each adhesive surface and a polished silver plate (silver purity >99.95%; size: 1 mm×10 mm×10 mm), metal corrosivity of the PSA sheet was determined using the metal corrosivity tester 50 shown in FIG. 3. That is to say, the PSA sheet 54 and the silver plate 56 were introduced inside a transparent glass screw bottle 52 of 50 mL in volume so as not to come into direct contact with each other, and the bottle was sealed. More concretely, the silver plate 56 was placed on the bottom surface of the screw bottle 52, the PSA sheet 54 was adhered on the back of the screw bottle cap 53, and the cap 53 was closed to seal the screw bottle 52. This was kept at 85° C. for one week. The silver plate after the test (after one week has elapsed) compared to an unused silver plate (prior to the test) and whether or not corrosion occurred (determined by the disappearance of metal sheen, alteration of external appearance such as coloration) was determined visually to evaluate metal corrosivity. The results are shown in Table 1, where metal corrosivity was “Present” if corrosion was observed, and metal corrosivity was “Absent” if no corrosion was observed.

<Braking Strength and Elongation at Break>

The breaking strength and elongation at break in the MD direction of the substrate prior to forming the PSA layer (for a surface-treated substrate, the substrate after surface treatment) were measured according to JIS C 2151.

<Anchoring Ability>

The first release liner of a double-sided PSA sheet was peeled off and a 23 μm-thick PET film was adhered for backing. This backed PSA sheet cut into a size of 20 mm in width and 100 mm in length served as a test piece. The second release liner of the test piece was peeled off, which was pressure-bonded with a 2 kg roller traveling back and forth once to a stainless (SUS: BA304) plate, which surface had been polished with a No. 360 grit sanding paper. This was maintained at 80° C. for 1 hour and then maintained at 23° C. for 1 hour. In a measurement environment of 23° C. temperature and 50% RH and under the conditions of 30 m/minute peel speed and 180° peel angle, the test piece was peeled off, the surface area of the PSA layer remaining on the stainless plate was measured and this surface area was divided by the total surface area of the PSA layer to calculate the proportion (%) of adhesive deposit surface area.

<Contact Angle>

For the substrate used in the preparation of the double-sided PSA sheet, the contact angle was measured 10 seconds after a droplet of water landed on the surface where a PSA layer is to be formed (that is to say, for a substrate that had been subjected to a surface treatment, the surface after the treatment), using an automatic contact angle meter (model “CA-V” manufactured by Kyowa Interface Science Co., LTD.) and according to the droplet method.

<Curved-Surface-Conformability>

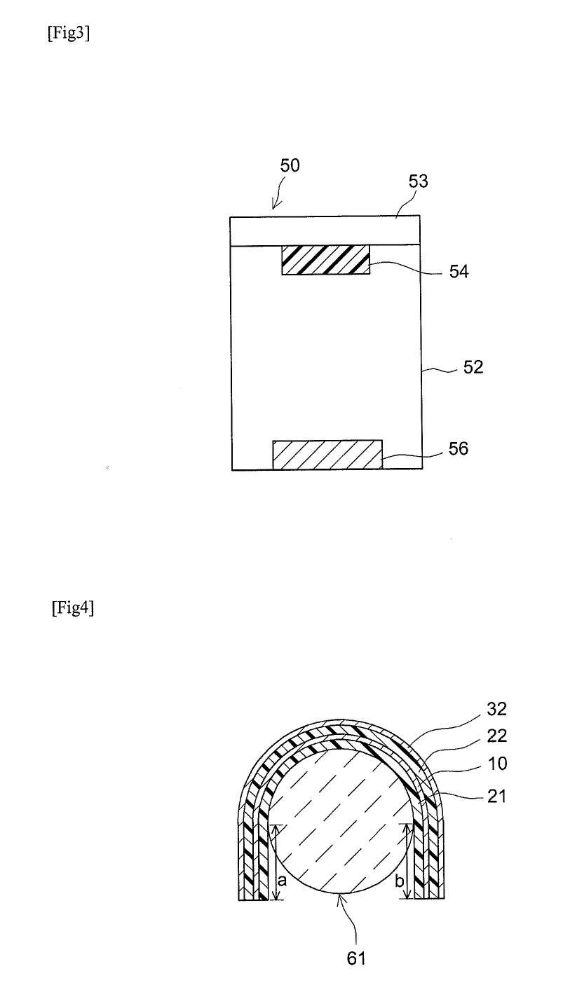

A test piece was prepared by cutting a double-sided PSA sheet to a size of 10 mm width×80 mm length. The first release liner was peeled off from this test piece and the exposed adhesive side (PSA layer 21) was adhered along the circumference of a 35 mm diameter×80 mm length (height) glass cylinder 61, which was pressure-bonded with a 1 kg roller traveling back and forth once along the circumference (FIG. 4). After this was maintained under an environment of 23° C. for 24 hours, the lengths a and b (mm) of each extremity resulting from the test piece peeling off and lifting from the cylinder were measured, and the sum thereof (a+b) served as the curved-surface-conformability.

TABLE 1

| | | Amount of | | Amount of | Amount of | |
|---|---|---|---|---|---|---|
| | Chain | SO₄²⁻ | | toluene | ethyl acetate | TVOC |
| | transfer | generated | Metal | released | released | amount |
| Example | agent | (μg/cm²) | corrosivity | (μg/g) | (μg/g) | (μg/g) |
| 1 | t-BuSH | <0.02 | Absent | <0.5 | <0.5 | 116 |
| 2 | t-LSH | <0.02 | Absent | <0.5 | <0.5 | 89 |
| 3 | PhSH | <0.02 | Absent | <0.5 | <0.5 | 121 |
| 4 | t-LSH | <0.02 | Absent | <0.5 | <0.5 | 146 |
| 5 | t-LSH | <0.02 | Absent | <0.5 | <0.5 | 47 |
| 6 | n-LSH | 0.047 | Present | <0.5 | <0.5 | 135 |
| 7 | t-LSH | <0.02 | Absent | <0.5 | <0.5 | 44 |
| 8 | t-LSH | <0.02 | Absent | <0.5 | <0.5 | 31 |
| 9 | t-LSH | <0.02 | Absent | 2140 | 74 | 2720 |
| 10 | t-LSH | <0.02 | Absent | <0.5 | 1710 | 1980 |
| 11 | t-LSH | <0.02 | Absent | <0.5 | <0.5 | 110 |

t-BuSH: tertiary butyl mercaptan
t-LSH: tertiary lauryl mercaptan
PhSH: phenyl mercaptan
n-LSH: n-lauryl mercaptan

TABLE 2

| | | | | | | | Adhesive | | |
|---|---|---|---|---|---|---|---|---|---|
| | Substrate | | | | | | deposit | | |
| | | Young's | | Breaking | Elongation | Curved-surface- | surface | Contact | Adhesive |
| | Thickness | modulus | Elasticity | strength | at break | conformability | area | angle | strength |
| Ex. | (mm) | (kPa) | coefficient E | (MPa) | (%) | (mm) | (%) | (degrees) | (N/20 mm) |
| 1 | 0.023 | 4 × 10⁶ | 48.7 | 235 | 173 | 0 | 0 | 56 | 13.7 |
| 2 | 0.050 | 4 × 10⁶ | 500 | 165 | 230 | 0 | 0 | 82 | 15.9 |
| 3 | 0.023 | 4 × 10⁶ | 48.7 | 235 | 173 | 0 | 0 | 87 | 14.4 |
| 4 | 0.002 | 6 × 10⁶ | 0.048 | 356 | 75 | 0 | 0 | 61 | 12.9 |
| 5 | 0.188 | 4 × 10⁶ | 26600 | 188 | 191 | 0 | 0 | 60 | 17.7 |
| 6 | 0.023 | 4 × 10⁶ | 48.7 | 235 | 173 | 0 | 0 | 56 | 14.9 |
| 7 | 0.250 | 4 × 10⁶ | 62500 | 191 | 199 | 30 | 0 | 59 | 18.3 |
| 8 | 0.342 | 4 × 10⁶ | 160000 | 161 | 187 | 60 | 0 | 65 | 19.3 |
| 9 | 0.023 | 4 × 10⁶ | 48.7 | 235 | 173 | 0 | 0 | 56 | 15.8 |
| 10 | 0.023 | 4 × 10⁶ | 48.7 | 235 | 173 | 0 | 0 | 56 | 16.4 |
| 11 | 0.023 | 4 × 10⁶ | 48.7 | 235 | 173 | 0 | 100 | 119 | 14.7 |

As shown in these tables, the double-sided PSA sheets according to Examples 1 to 5 and 7 to 11, which used a tertiary alkyl mercaptan or an aromatic mercaptan as the chain transfer agent, all demonstrated satisfactory adhesive strength, and the amount of sulfur-containing gas generated was 0.043 μg SO₄²⁻/cm² or lower (more concretely less than 0.02 μg SO₄²⁻/cm²). Then, these double-sided PSA sheets according to Examples 1 to 5 and 7 to 11 were all verified to not corrode silver in the metal corrosivity test described above. Meanwhile, with Example 6, which uses n-lauryl mercaptan (primary alkyl mercaptan) as the chain transfer agent, although adhesive strength and cohesive strength were similar to those of Examples 1 to 5 and 7 to 11, the amount of sulfur-containing gas generated was abundant, and it was verified to corrode silver in the metal corrosivity test described above. That is to say, according to Examples 1 to 5 and 7 to 11, the remarkable effect of solving the problem of metal corrosivity while maintaining adhesive capabilities to similar extents to Example 6 was realized.

In addition, as shown in Table 2, compared to the double-sided PSA sheet of Example 11 which used a substrate with no surface treatment performed, the double-sided PSA sheets according to Examples 1 to 10 which quality had been improved by having the substrate surface treated by corona discharge, conferred an undercoat layer, or the like, have all been recognized to have an excellent anchoring ability. Among them, the double-sided PSA sheet of Examples 2 and 3 with an undercoat layer containing an oxazoline group conferred on the substrate both had a water contact angle on the substrate surface thereof clearly increased compared to the double-sided PSA sheet according to Examples 1 and 4 to 10 which had no undercoat layer. Consequently, it is assumed that these double-sided PSA sheets may demonstrate even better anchoring abilities when measurements of adhesive deposit surface areas are performed under more stringent conditions.

In addition, compared to the double-sided PSA sheets of Examples 7 to 8 in which the bending elasticity coefficient exceeds 5×10⁴, the double-sided PSA sheets of Examples 1 to 6 and 9 to 11 in which the bending elasticity coefficient of the plastic substrate is 5×10⁴ or less demonstrated a more satisfactory curved-surface-conformability.

In addition, compared to the double-sided PSA sheets of Examples 9 and 10 which use a solvent type PSA composition, the double-sided PSA sheets of Example 1 to 8 and 11 which use a water dispersed system PSA composition demonstrated satisfactory results with remarkably low toluene emission and/or ethyl acetate emission, and TVOC amounts of 500 μg/g or less for all.

With that, specific examples of the present invention were described in detail; however, these are mere illustrations and do not limit the scope of the claims. The art recited in the claims includes various variations of and modifications to the specific examples illustrated above.

What is claimed is:

1. A double-sided pressure-sensitive adhesive sheet comprising a plastic film substrate and a pressure-sensitive adhesive layer formed from a water-dispersed pressure-sensitive adhesive composition and provided on each side of said substrate, wherein
said pressure-sensitive adhesive composition comprises a water-dispersed acrylic polymer synthesized using a chain transfer agent containing sulfur as a structural element, and
in a gas generation test under which said pressure-sensitive adhesive sheet is heated at 85° C. for one hour, the emission of gas containing sulfur as a structural element is 0.043 μg or less per 1 cm² surface area of said sheet when converted to SO₄²⁻.

2. The double-sided pressure-sensitive adhesive sheet according to claim 1, wherein said chain transfer agent is a chain transfer agent that does not essentially generate said gas in said gas generation test.

3. The double-sided pressure-sensitive adhesive sheet according to claim 1, wherein said chain transfer agent comprises as a main component a mercaptan with a structure having no hydrogen atom on a carbon atom bonded to a mercapto group.

4. The double-sided pressure-sensitive adhesive sheet according to claim 3, wherein said mercaptan is one, two or more species selected from the group consisting of tertiary mercaptans and aromatic mercaptans.

5. The double-sided pressure-sensitive adhesive sheet according to claim 1, wherein the amount of toluene emitted from said sheet when said pressure-sensitive adhesive sheet is maintained at 80° C. for 30 minutes is 20 μg or less per gram of said sheet.

6. The double-sided pressure-sensitive adhesive sheet according to claim 1, wherein the amount of ethyl acetate emitted from said sheet when said pressure-sensitive adhesive sheet is maintained at 80° C. for 30 minutes is 20 μg or less per gram of said sheet.

7. The double-sided pressure-sensitive adhesive sheet according to claim 1, wherein the total amount of volatile organic compounds emitted from said sheet when said pressure-sensitive adhesive sheet is maintained at 80° C. for 30 minutes is 500 μg or less per gram of said sheet.

8. The double-sided pressure-sensitive adhesive sheet according to claim 1, wherein said plastic film substrate, when the Young's modulus thereof is Y (kPa) and the thickness thereof is h (mm), has a bending elasticity coefficient E represented by the following formula (A): E=Yh³; of 5×10⁴ or less.

9. The double-sided pressure-sensitive adhesive sheet according to claim 1, wherein the thickness of said plastic film substrate is 1 μm or greater and 300 μm or less.

10. The double-sided pressure-sensitive adhesive sheet according to claim 1, wherein at least one treatment selected from the group comprising corona discharge treatment, plasma treatment and ITRO treatment has been performed on each side of said plastic film substrate.

11. The double-sided pressure-sensitive adhesive sheet according to claim 1, wherein each side of said plastic film substrate has an undercoat layer containing an oxazoline group.

12. The double-sided pressure-sensitive adhesive sheet according to claim 11, wherein the thickness of said undercoat layer is 0.01 μm or greater but less than 3 μm.

13. The double-sided pressure-sensitive adhesive sheet according to claim 1, wherein a plastic film substrate surface where said pressure-sensitive adhesive layer is formed has a water contact angle of 0 degrees or greater and 90 degrees or less.

14. The double-sided pressure-sensitive adhesive sheet according to claim 1, wherein said plastic film substrate is a polyester film.

15. The double-sided pressure-sensitive adhesive sheet according to claim 1, which is used inside an electronic device.
